(19) United States
(12) Patent Application Publication
(10) Pub. No.: US 2019/0065028 A1
(43) Pub. Date: Feb. 28, 2019

(54) AGENT-BASED PLATFORM FOR THE DEVELOPMENT OF MULTI-USER VIRTUAL REALITY ENVIRONMENTS

(71) Applicants: Vitaly Chashchin-Semenov, San Jose, CA (US); Sergey Kudryavtsev, San Jose, CA (US)

(72) Inventors: Vitaly Chashchin-Semenov, San Jose, CA (US); Sergey Kudryavtsev, San Jose, CA (US)

(73) Assignee: Jedium Inc., San Jose, CA (US)

(21) Appl. No.: 16/118,992

(22) Filed: Aug. 31, 2018

Related U.S. Application Data
(60) Provisional application No. 62/553,009, filed on Aug. 31, 2017.

(51) Int. Cl. G06F 3/0481; G06T 19/20; G06F 3/0484

(52) U.S. Cl. CPC G06F 3/04815; G06T 19/20; G06F 3/04847; G06F 3/04845; H04L 67/42; G06T 2219/2012; G06T 2219/2004; G06T 2200/24; G06T 2219/024

(57) ABSTRACT

Systems and methods are presented for a virtual reality platform that allows for objects to be created in a first virtual environment, and then shared for use and modification in a second virtual environment that did not originally create the object. An object may be developed, then saved to a shared space. The object can then be loaded into a new virtual environment having all the same properties and characteristics already present in the originally created and saved object. The virtual reality platform of the present disclosure may be implemented as an agent-based platform, meaning each object is an independent agent that includes a local copy of the object, as well as a shared copy of the object on the server side. This allows each object to be replicated for any user, based on the shared global object on the server side.

### CROSS REFERENCE TO RELATED APPLICATION

This application claims priority to U.S. Provisional Application 62/553,009, filed Aug. 31, 2017, and titled, “AGENT-BASED PLATFORM FOR THE DEVELOPMENT OF MULTI-USER VIRTUAL REALITY ENVIRONMENTS,” the disclosure of which is hereby incorporated herein in its entirety and for all purposes.

### TECHNICAL FIELD

The subject matter disclosed herein generally relates to processing data in a 3-dimensional (3D) virtual reality environment. In some example embodiments, the present disclosures relate to methods and systems for an agent-based platform for the development of multi-user virtual reality environments.

### BACKGROUND

Virtual reality (VR) is a burgeoning field that has the potential to allow for near limitless possibilities in creativity and development. The infrastructure needed to allow many users to develop and use the environment is a limitation, however, that needs to be supported with proper hardware and efficient system architecture. Furthermore, efficient architectures for allowing developers to build VR objects to allow other users to share and utilize is not a trivial task, particularly when building a 3D platform with manageable scalability. It is desirable to design a VR platform that allows the sharing of objects created by one user to be used by another user, while still allowing for a high degree of scalability to account for an arbitrary number of users.

### BRIEF SUMMARY

Aspects of the present disclosure are presented for a platform that allows people to build multi-user dynamic virtual environments. In some embodiments, the platform is a constructor (like wix.com for the web) allowing people (even without technical background) to reuse content that was built by 3rd party developers.

For developers, the platform of the present disclosures allows for the creation of scenarios of behavior for every entity in a virtual environment, combining several entities into one entity and create a scenario for that larger entity. For example, training course can be created that include various entities: 3D models (chairs, tables, avatars), text explanations, To-Do, exams, etc. The course itself is an entity. Other people could reuse the created content (the entire course or parts/entities) in their own virtual spaces.

In some embodiments, a system of a virtual reality (VR) platform for generating shared entities in a plurality of virtual reality environments is presented. The system may include: a first client portal configured to interface with a first user; a first VR client domain communicatively coupled to the first client portal and configured to: generate a first VR entity based on input by the first user, the first VR entity comprising visual characteristics and physical characteristics that can be interfaced within VR environments; and cause display of the first VR entity generated by the first user; a first data domain communicatively coupled to the first VR client domain and configured to store data associated with the visual and physical characteristics of the first VR entity; a server communicatively coupled to the VR client and the first data domain and configured to store a global entity agent associated with the first VR entity, the global entity agent representing a global copy of the first VR entity comprising the same visual and physical characteristics as the first VR entity; a second data domain communicatively coupled to the server and configured to access a copy of the global entity agent and store the copy as a second VR entity, the second VR entity comprising the same visual and physical characteristics as the global entity agent; a second VR client domain communicatively coupled to the second data domain and configured to: download the second VR entity based on input of a second user; and cause display of the second VR entity, wherein the display of the second VR entity comprises the same visual and physical characteristics as the first VR entity; and a second client portal communicatively coupled to the second VR client domain and configured to interface with the second user.

In some embodiments of the system, the first client portal is further configured to receive an instruction from the first user to change a characteristic about the first VR entity; the first data domain is further configured to change the characteristic about the first VR entity and store the change; the first VR client domain is further configured to cause display of the changed characteristic about the first VR entity; and the server is further configured to automatically change a same characteristic about the global entity agent based on the received instruction from the first user.

In some embodiments of the system, the second data domain is further configured to access the changed characteristic of the global entity agent and automatically change a same characteristic about the second VR entity; and the second VR client domain is further configured to automatically cause display of the changed characteristic about the second VR entity, based on the received instruction from the first user.

In some embodiments of the system, the first data domain is further communicatively coupled to the first client portal, and the second data domain is further communicatively coupled to the second client portal.

In some embodiments of the system, the first VR client domain is further configured to cause display of a first entity user interface configured to receive input to manipulate the first VR entity.

In some embodiments of the system, the server is configured to cause a plurality of copies of the global entity agent that are each stored in different data domains to automatically change to a same characteristic in the plurality of copies whenever the same characteristic in the global entity agent is changed.

In some embodiments of the system, the server is further configured to store a room agent associated with a room environment of the first VR client domain, the room agent comprising visual and physical characteristics associated with the room environment in the first VR client domain.

In some embodiments of the system, the instruction from the first user to change the characteristic about the first VR entity is generated by a programming language script.

In some embodiments of the system, the first VR client domain is further configured to be interfaced by the first user and the second user simultaneously.

In some embodiments, the system further comprises a streaming server configured to cause display of both the first VR entity in the first VR client domain and the second VR entity in the second VR client domain.

In some embodiments, a method of a virtual reality (VR) platform for generating shared entities in a plurality of virtual reality environments is presented. The method may include: interfacing with a first user at a first client portal of the VR platform; generating, at a first VR client domain of the VR platform, a first VR entity based on input by the first user, the first VR entity comprising visual characteristics and physical characteristics that can be interfaced within VR environments; causing display of the first VR entity generated by the first user; storing, in a first data domain of the VR platform, data associated with the visual and physical characteristics of the first VR entity; storing, in a server of the VR platform, a global entity agent associated with the first VR entity, the global entity agent representing a global copy of the first VR entity comprising the same visual and physical characteristics as the first VR entity; accessing, by a second data domain of the VR platform, a copy of the global entity agent; storing, by the second data domain, the copy as a second VR entity, the second VR entity comprising the same visual and physical characteristics as the global entity agent; downloading, by a second VR client domain of the VR platform, the second VR entity based on input of a second user; causing display of the second VR entity, by the second VR client domain, wherein the display of the second VR entity comprises the same visual and physical characteristics as the first VR entity; and interfacing with the second user by a second client portal of the VR platform.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2A shows additional details of the structural implementation of the virtual reality platform, according to some embodiments.

FIG. 2B shows an alternative structural block diagram according to some embodiments, focusing primarily on the interactions between the client side and the server side of the virtual reality platform.

FIG. 3 shows more of a software layer describing the interactions between the four domains of FIG. 2A, according to some embodiments.

FIG. 4 shows a simplified version of what a user may see when interacting with a VR environment of the present disclosures.

FIGS. 5-13 show example screenshots to illustrate how the VR platform of the present disclosures allows for objects to be generated by a first user, and then shared to a second user and others having the same properties as created by the first user.

FIG. 5 shows an example VR environment of a first user creating a first object.

FIG. 6 shows a first and second user in the first VR environment with the first object.

FIG. 7 shows an example script for changing a property of the first object in the first VR environment.

FIG. 8 shows an example of a property of the first object being changed in the first VR environment.

FIG. 9 shows an example of a second VR environment inhabited by the second user.

FIG. 10 shows a second object that is a copy of the first object being downloaded into the second VR environment.

FIG. 11 shows the property of the first object that was changed is also reflected in the downloaded copy of the second object, in the second VR environment.

FIG. 12 shows a property of the first object being changed again in the first VR environment.

FIG. 13 shows the property that was changed in FIG. 12 is automatically updated in the second object in the second VR environment.

FIG. 14 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for an agent-based platform for the development of multi-user virtual reality environments.

In the technical field of virtual reality development and use, several problems exist that can be improved upon or solved. For example, for developers, it would be desirable to create objects that can be shared across multiple environments for other users.

A typical solution for a multi-threading model of a virtual reality environment systems is ECS (Entity-Component System). It represents an object as a set of data-only components (for example, position, color, etc.) and introduces a number of “workers,” which are essentially global objects processing all updates for each entity. For example, if there are ten moving balls in an environment, the position worker will update the position of each ball for each position component. By using this approach, it is relatively easy to scale the system, because there may be a number of workers for each type of components that process them in parallel. This is a typical usage of actor systems (e.g., every worker is an actor).

However, in the case of user-created content, especially, user-scripted content, it would be difficult because the ECS concept is not intuitive and cumbersome to use for non-expert developers. Also, it would be tough to deploy a set of new workers in another environment in case of transferring an object between environments.

In general, the current situation is that conventionally, if a developer wants to create a new application for any existing virtual environments, he/she should solve a lot of technical problems with communication protocols, interfaces, multi-user interaction, etc. The developer is limited in scripting languages he/she can use.

In addition, there is a scalability problem. For example, say a VR app is sold to “Company A” with 10 employees. Then, the VR app is sold to “Company B” with 10,000 employees. Conventionally, a developer is forced to work on the back-end to be sure that everything would fine if 10,000 would be simultaneously connected. Using the ECS model solution, every individual worker would need to be updated in order for all users to experience or have included the same changed objects in their space.

Aspects of the present disclosure allow for the creation of multi-user VR applications in a convenient way (like a development of a single-user application for a modern operating system). A new architecture is introduced, where the logical representation of an object (for example, a ball in VR) is combined with its threading model (an agent or an actor). That is not a trivial approach to design an architecture. A pure ECS solution is not deployed in this system. Instead, each actor has a set of “micro-workers” (one for each object component). Taking in account that each actor may work in its own thread (or on a separate PC/a cluster), the system becomes very flexible and scalable. In addition, the architecture provides an ability to script the entities easily and transfer them between different environments.

Moreover, in contrast to the difficulty of scalability use the ECS approach, aspects of the present disclosure can handle both companies (Company A and Company B, as mentioned above) very easily. The VR app of the present disclosure is deployed without needing to develop a back-end infrastructure.

In addition, for non-technical users, the VR platform of the present disclosures provides an opportunity to build virtual worlds without writing original code on their own.

In general, the virtual reality platform of the present disclosure allows for objects to be created in a first virtual environment, and then shared for use and modification in a second virtual environment that did not originally create the object. This is unlike conventional platforms that generate individual virtual environments. Typically, the objects and characteristics of any virtual environment cannot be saved then transferred or shared across another environment. This is different than simply recreating the object in a new environment, which can be done normally. In this case, an object may be developed, then saved to a shared space. The object can then be loaded into a new virtual environment having all the same properties and characteristics already present in the originally created and saved object.

The virtual reality platform of the present disclosure may be implemented as an agent-based platform, meaning each object is an independent agent that includes a local copy of the object, as well as a shared copy of the object on the server side. This allows each object to be replicated for any user, based on the shared global object on the server side. This is unlike classic virtual environments that may be built on servers employing conventional means for supporting VR realms, wherein the VR environments allow only for the creation of the local environment and objects therein in which they were originally created.

Here, the objects are persistent and can exist beyond the environment they were originally created in. This may be accomplished due to the scalability of the architecture of this present platform. While a single environment is not a problem, a server side infrastructure can have great difficulty in trying to support many virtual environments at the same time. On the other hand, the platform of the present disclosure can scale the number of users much more easily, due to the agent-based implementation of the environments as well as the objects in the environments. The agents are dynamically run, and independent, capable of each receiving messages from each other agent. This is in contrast to each environment being a discrete entity with all of the objects integrated in their totalities in conventional implementations. According to the present disclosure, the agent-based approach allows for any number of agents to exist, independent of which environment they were generated from, and independent from what server they originally existed in.

In some embodiments, the highly scalable server for a dynamic virtual environment allows the user to create a content of any visual/programmatic complexity by using any software for 3D design/modeling and any language supported by .NET platform.

In some embodiments, the nature of the platform, as implemented, allows the developer to install the server part and gives the access to others via the client part. The client part allows people to: (a) upload a new content of any complexity, and (b) use any text editor to code the behavior of the object in any .NET language. The virtual reality platform provides an API to write such code in a way a modern operating system does (by providing all necessary functions for VR, user UI and network interactions.), in some embodiments.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

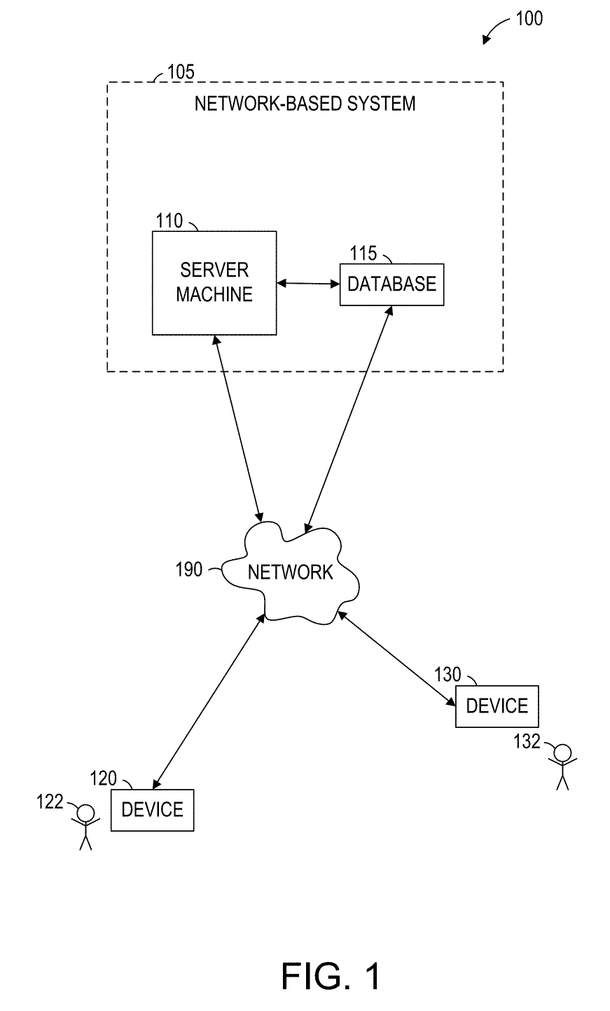

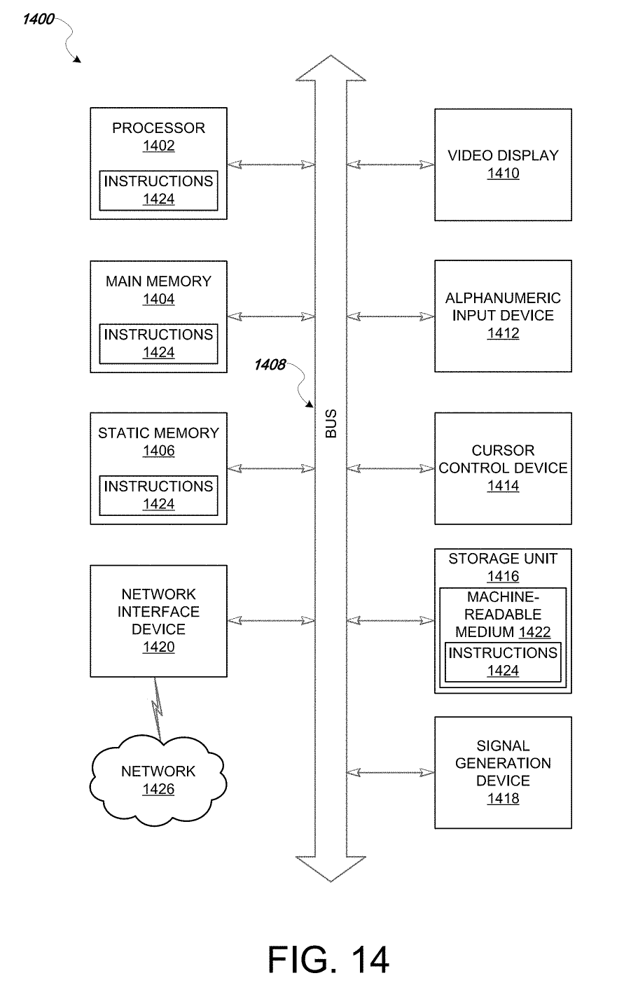

Referring to FIG. 1, a network diagram illustrating an example network environment 100 suitable for performing aspects of the present disclosure is shown, according to some example embodiments. The example network environment 100 includes a server machine 110, a database 115, a first device 120 for a first user 122, and a second device 130 for a second user 132, all communicatively coupled to each other via a network 190. The server machine 110 may form all or part of a network-based system 105 (e.g., a cloud-based server system configured to provide one or more services to the first and second devices 120 and 130). While only one server is shown, multiple servers may be connected and distributed in an agent-based approach such that no single VR environment of a user need be confined to the single server in which it was originally created. For the sake of simplicity, a single server 110 is mentioned, but embodiments are not so limited. The server machine 110, the first device 120, and the second device 130 may each be implemented in a computer system, in whole or in part, as described below with respect to FIG. 14. The network-based system 105 may be an example of an agent-based platform for providing multiple virtual reality realms for multiple users. The server machine 110 and the database 115 may be components of the virtual reality platform configured to perform these functions. While the server machine 110 is represented as just a single machine and the database 115 where is represented as just a single database, in some embodiments, multiple server machines and multiple databases communicatively coupled in parallel or in serial may be utilized, and embodiments are not so limited.

Also shown in FIG. 1 are a first user 122 and a second user 132. One or both of the first and second users 122 and 132 may be a human user, a machine user (e.g., a computer configured by a software program to interact with the first device 120), or any suitable combination thereof (e.g., a human assisted by a machine or a machine supervised by a human). The first user 122 may be associated with the first device 120 and may be a user of the first device 120. For example, the first device 120 may be a desktop computer, a vehicle computer, a tablet computer, a navigational device, a portable media device, a smartphone, or a wearable device (e.g., a smart watch or smart glasses) belonging to the first user 122. Likewise, the second user 132 may be associated with the second device 130. As an example, the second device 130 may be a desktop computer, a vehicle computer, a tablet computer, a navigational device, a portable media device, a smartphone, or a wearable device (e.g., a smart watch or smart glasses) belonging to the second user 132. The first user 122 and a second user 132 may be examples of users or customers or developers interfacing with the network-based system 105 to utilize the agent based platform for their specific needs, including generating virtual objects to build their virtual environment while also allowing theirs to be shared by other users. In other cases, the users 122 and 132 may be examples of non-technical users who utilize the generated virtual objects having all of the previously generated characteristics of said objects. The non-technical users can then modify the object to fit their own uses and style. The users 122 and 132 may interface with the network-based system 105 through the devices 120 and 130, respectively.

Any of the machines, databases 115, or first or second devices 120 or 130 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 120 or 130. For example, a computer system able to implement any one or more of the methodologies described herein is discussed below with respect to FIG. 14. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

In some embodiments, the system architecture of the VR server is implemented in a multi-threading model. This paradigm includes multiple agents (or actors), where each actor is implemented to run on its own thread. For example, in Akka.NET, actor behavior could be configured using a dispatcher, which are responsible for the code that runs inside the actor system. If the representation of a virtual environment is implemented as an actor system, every object in that system is represented by an actor and could be configured to use its own thread.

In this type of architecture, to transfer an object to a different VR space, there may be two options:

1. Use an actor's location transparency. This means that actors exist in a distributed setting where all interactions of actors use purely message passing and everything is asynchronous. This allows for all functions of an actor to be available equally when running on one or more machines. For example, say there are two virtual environments where servers have addresses, e.g., “example1.com” and “example2.com.” A user wants to use an actor from “example1” in “example2.” It is known the address of an actor (like akka.tcp://MyVirtualWorld@example1.com/actors/RedBall). When the user logs in, he gets the list of all the actors on the scene and creates a client-side actor system, which is a copy of a server one. Then, each actor of the client-side system establishes a connection with a server-side actor, using the server actor address. In order to use an actor from “example1.com” in “example2.com,” it may simply take passing the client an address of an actor from “example1.com.” In that case, an actor is hosted on “example1.com” and may use a thread on the “example1.com” server.

2. An ability to reuse an “offline” actor, by re-deploying it on another actor system. In the previous example, “example1.com” was online. That's why a user can simply connect to it from “example2.com.” If it is not an option, then an actor “snapshot” can be used, e.g., a state of an actor, including its visual representation, behaviors (for example, if a user can pick up a ball), and custom scripts. All of that could be stored in the form of a file or a number of database records. This file will need be to be read on “example2.com” and a new actor will need to be deployed (identical to the actor on “example1.com”). However, in that case, such actor is a part of the “example2.com” actor system and uses the resources (including threads) from it.

These types of example implementations would be difficult to realize using the typical ECS concept. This is because the ECS concept is not developed in the design of “OOP” (Object-Oriented Programming). For example, in order to change the color of a ball in VR when it is touched, it would be pretty straightforward without ECS: just subscribe to the “touched” event of a ball object and set its color. The only thing that may also be needed is to create a variable to store the previous color and subscribe to an “untouched” event to restore the old color if needed. However, in ECS, a new component needs to be created, which would contain color, a “touched” state, and a worker, which checks the state of the component and change object's color. A component is an additional data structure, and a worker is an additional mini-program; both are small in that case, but the whole setup would quickly become complex and non-intuitive in a more complicated scenario.

Further to this example, the ECS concept makes copying properties of an object in one VR environment very cumbersome to implement in another VR environment. A worked would need to be deployed to every object in every other VR environment in order to implement the change of the color of the ball. If a user wants to transfer the ball from the previous example to another server, he will need to deploy a custom worker. If the object is complex, it will include some workers, and making the change globally across multiple servers will simply multiply the number of workers needed to implement a single change.

In contrast, the architecture of the present disclosure that combines the logical representation of an object and its threading model (e.g., an agent or an actor), allows for a much easier and more efficient mechanism for changing properties of a user-created object and transferring the same change to multiple environments from an originating environment.

Described herein is one example of the process flow that describes the architecture according to some embodiments. This may be implemented by the network-based system of FIG. 1, for example. In some embodiments of the architecture of the present disclosure, every object is a hierarchical set of actors. The root actor contains some object metadata (unique id, name, other basic properties) and a list of behaviors, or components. A behavior is some kind of a standard object part, an object position in a virtual space, for example.

When a client connects to the system, the client receives a list of objects and deploys a client-side actor of an object. Then it connects to the server-side object.

When a server-side object receives a request from a client-side object to connect, the root actor spawns a new sub-actor, which is responsible for sending and receiving messages from/to the client and sending a list of behaviors to the client.

When a client object receives a list of behaviors, the client actor creates a set of client representations of object behaviors. For example, in the case of position behavior, it means that the client object starts reacting to position messages and sends them. When a user changes the position of an object, it creates a message with a new position and sends it to the server. When the server-side client connection receives new position messages, it sends it to the root actor of the server object. Then, the root actor sends a message to the behavior of that message type (in this case, a position behavior).

When a behavior receives a message, it processes it (in this case, it just updates the stored position and—in some cases—updates the position of the object in a database), generates a response message (in this case, just the same message about position change) and sends it to the root object. When the root object receives a response message, it sends it to clients (in this case, to all except the sender) using the sub-actors for connected clients.

When a client receives the position message, it processes it using the client-side behavior (in this case, just changes the position of an object). So the position change is synchronized on all clients.

A behavior (or component) contains four parts: server-side, client-side, message description, and snapshot. Server-side and client-side behaviors process the messages. Messages are defined in a message description part. The snapshot is a copy of the state of behavior, which could be saved in a database. The behavior could be called a “mini-worker” if messages are treated or viewed as ECS components.

Regarding user scripting, each user script is a behavior too, but all parts of the behavior are hidden from a developer. The user code is compiled into a .dll, loaded into behavior and—in fact—processes the same sort of messages, according to some embodiments.

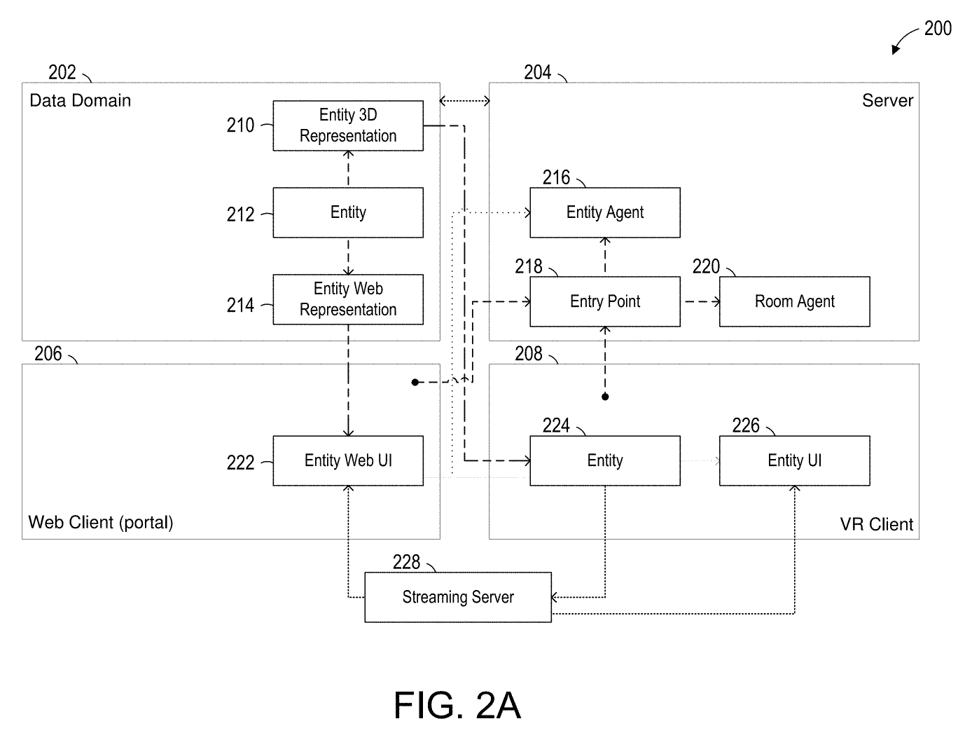

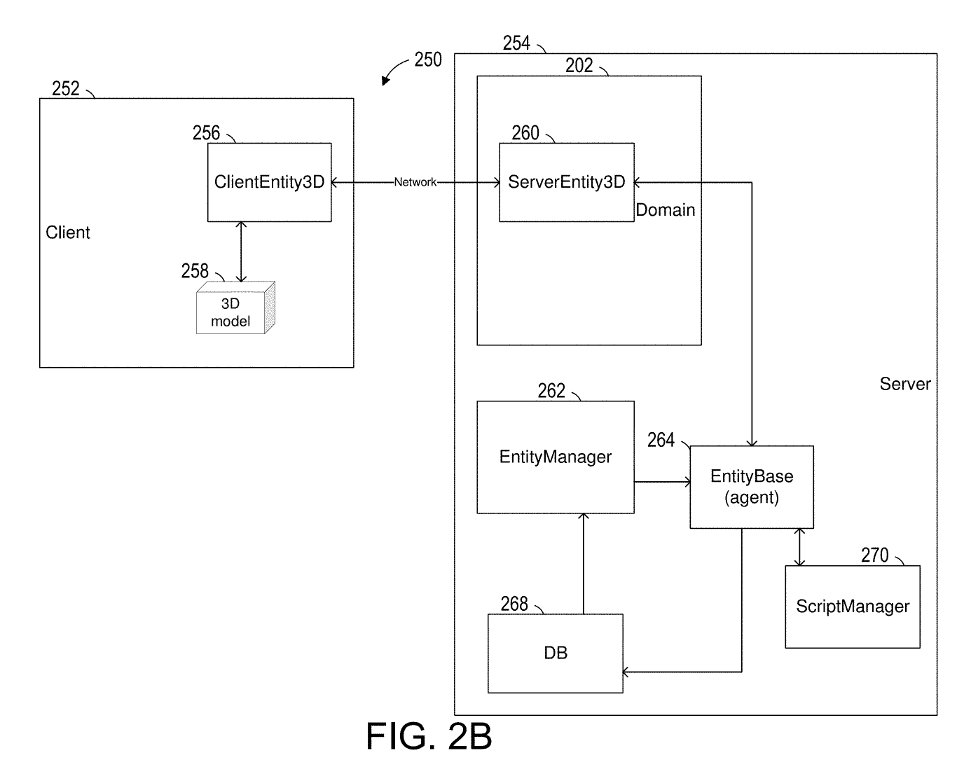

Referring to FIG. 2A, shown are additional details of the structural implementation of the virtual reality platform, according to some embodiments. In this example diagram 200, the server 204, such as server machine 110, is communicatively coupled to a web client 206 or other type of portal, as shown. The server 204 may provide a VR client 208 that can be interfaced by the web client 206, via device 120 or 130 for example. The server 204 also provides the data domain 202 which includes the necessary memory and data for providing the content in the VR client 208. The data domain 202 may be stored in one or more databases, such as database 115. The VR client 208 may be viewable through the web client 206 and therefore viewable on the device 120 or 130, for example.

As shown in this example, the server 204 contains an entity agent 216, that may be accessed through an entry point 218. The entry point 218 may also allow access to a room agent 220. As mentioned above and will be mentioned in more detail below, the virtual reality platform of the present disclosure may implement each of the discrete objects in a virtual reality environment as separate and independent agents. In this case, an entity, such as any object or avatar, may be implemented as an agent. In addition, the room itself may be implemented as an agent.

The VR client 208, which may be viewed in the device 120 or 130, includes at least one entity 224, such as a virtual reality avatar. The data used to represent the entity 224 may be supported in the data domain 202. A user interface 226 for the entity is also contained and displayed in the VR client 208. The VR client 208 may also be configured to access various other entity agents and/or room agents via the entry point 218 of the server 204. The VR client 208 is typically displayed via the streaming server 228.

The data domain 202, as shown, may include data for a 3-D representation 210 of any entity (e.g., entity 224). The data domain 202 may also include a global version 212 of the entity, that may be downloaded and shared to other client devices. The data domain may also include a web representation 214 of the entity that may be more suitable for being shared.

Still referring to FIG. 2A, a human user will typically start engagement of the VR environment through a web client 206. The web client 206 may contain an entity web user interface 222 that can then lead into the VR client 208, ultimately allowing access to the various entity agents and room agents. The data domain 202 provides the data necessary to support the web client 206 and the objects seen in the web client 206 via the VR client 208. The server 204 provides the agent representation 216 of the entity, as well as the agent representation 220 of the room. The web client 206 also is typically displayed via a streaming server 228.

As described above, with this example architecture, a change made to one user created object via the web client may be easily propagated to other VR clients interfaced by other users. A change to an entity 224 in the VR client 208 may be saved at both the server 204 (e.g., using the entity agent 216) and the data domain 202 (e.g., using the global version 216 that is saved as a more local version 212 of the entity). By maintaining both a global version and a local version, it is more efficient to propagate changes to other VR domains.

Referring to FIG. 2B, shown in illustration 250 is an alternative structural block diagram according to some embodiments, focusing primarily on the interactions between the client side 252 and the server side 254 of the virtual reality platform. In this example, the client side 252, such as device 120 or 130, includes a 3-D client entity module 256 that is configured to display the VR environment and provide access and interaction to the VR environment by the user. The 3-D client entity module 256 is loaded up and run on the client side using a 3-D model engine 258.

The 3-D client entity module 256 may be communicatively coupled via a network connection to a 3-D server entity module 260 on the server side 254, as shown. This 3-D server entity module 260 exists within one data domain 202 supported on the server-side 254. It is noted that there may be multiple data domains, where each is used to support one or more virtual reality environments, each for different users. Each 3-D server entity module 260 may include at least one entity base agent 264, an entity manager 262, at least one database 268, and a script manager 270. These modules provide particular functionality for operating each VR environment. For example, the base agent 264 may be the minimum agent for supporting each entity. The entity manager 262 may be configured to coordinate or facilitate communications between the entity and the various components associated with the entity, such as communications to the server and handling edits or updates to the entity. The at least one database 268 may store the data related to the entity. The script manager 270 may handle the interface for generating scripts and for applying the scripts to update or create new entities.

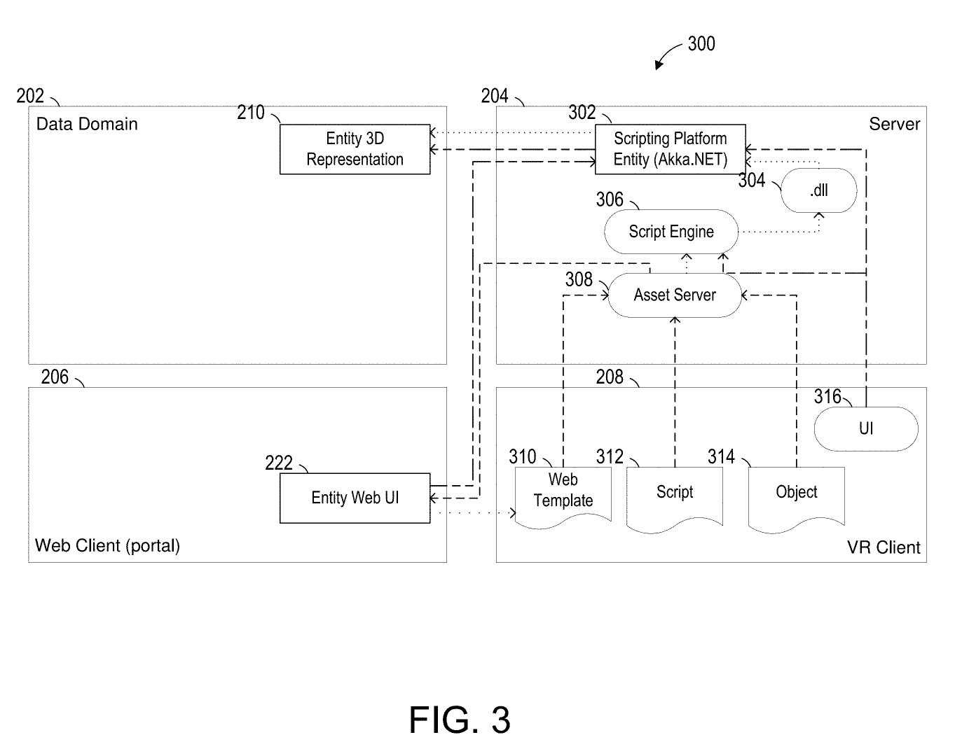

Referring to FIG. 3, shown in illustration 300 is more of a software layer describing the interactions between the four domains of FIG. 2A, according to some embodiments. Starting with the server 204, such as server machine 115, in some embodiments, the VR platform is built using a scripting platform program 302, such as Akka.NET, although other programming languages may certainly be used, and embodiments are not so limited. One or more dynamically linked libraries (.dll's) 304 may be compiled, which supports a scripting engine 306 that is used to create any number of agents in a virtual reality environment. An asset server engine 308 is included to support the functionality of the various other software components, described more below. The asset server may be configured to provide actual visualizations of the entities, such as by generating 3D models and textures for display in the VR environment.

As one example, a server 204, according to some embodiments, has been built by using the Akka.NET multi-agent framework. All objects (e.g., entities) in a VR environment are implemented as an independent Akka.NET agent. This allows a system administrator to scale the server-side for each entity from a single OS thread to a cluster. All entities implement the API that is required to code every possible interaction and event in a virtual environment or in network. .NET implementation gives an ability to load and execute a user's code in a form of a dynamically linked library for every entity.

Possible applications built with the VR platform of the present disclosure include every case of a persistent and active multi-user virtual environment. The VR platform may be focused on e-learning applications and provides all necessary capabilities to: (a) implement complex multi-user training scenarios, and (b) build integrations with any existing e-learning software (LMS, LCMS, etc.). The VR platform includes an xAPI implementation, according to some embodiments, which provides all required statistics for training sessions in such environments. Statistics are gathered in a form of each individual (per trainee). A Big Data set that is suitable for data mining may be generated in the aggregate. Data mining could be used for creation of an individual learning trajectory and identification of gaps in knowledge.

In the data domain 202, 3-D representations 210 of every entity are stored. The server 204 may be configured to upload and download each of the 3-D representations, and may also store in the data domain all scripts and functions and properties related to each entity. A copy of each entity from the data domain 202 may then be transmitted to any virtual reality environment, such that every virtual reality environment can utilize any entity created by any other user that is stored in the data domain 202.

In the VR client 208, various software modules include one or more objects 314, one or more scripts 312, one or more web templates 310, and at least one UI 316, wherein each of the aforementioned modules are communicatively coupled to the asset server 308. It can be seen how the scripts and objects and user interfaces are generated based on the structural modules described in FIG. 2A.

At the web client 206, the entity web user interface 222 is present, and interacts between the asset server 308 of the server-side 204, the web template 310 at the VR client 208, and is being powered by the programming language entity 302, such as the Akka.NET entity.

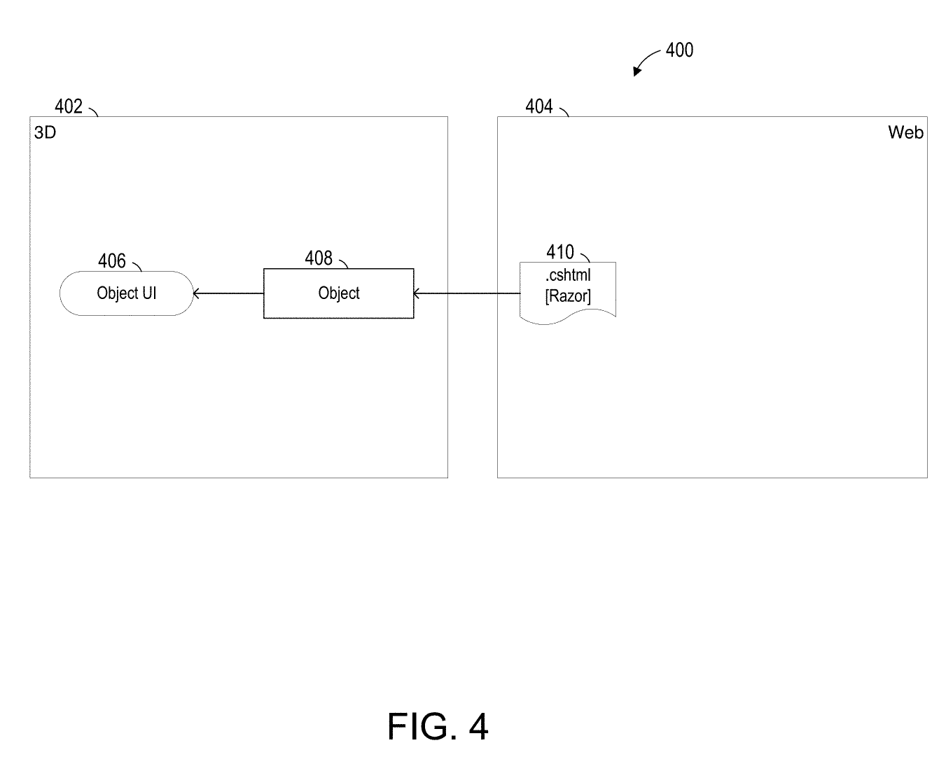

Referring to FIG. 4, shown in illustration 400 is a simplified version of what a user may see when interacting with a VR environment of the present disclosure. From this perspective, the user may only see the 3-D virtual environment 402, and portions of functionality from the web portal. While in the 3-D environment 402, the user can create objects 408, modify objects, and interact with the objects. Scripting code for defining the properties of the object may be provided in the web client, utilizing for example, .cshtml. A user interface 406 for each of the objects is also available in the 3-D client 402, when the user selects the object, for example. This allows the object to be manipulated, such as be moved around, change colors, and define other properties about the object.

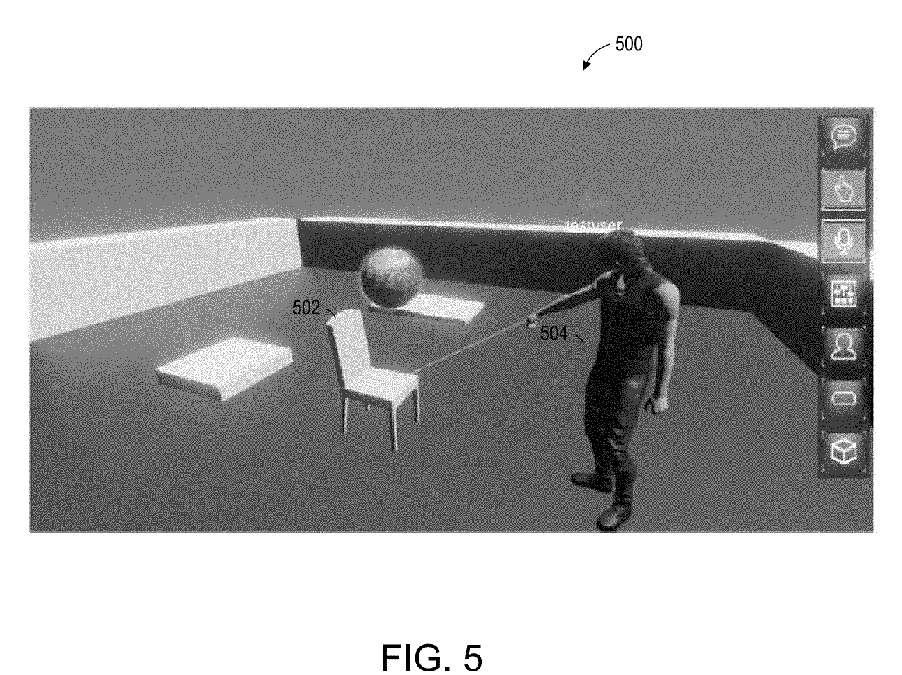

Referring to FIGS. 5-13, the following example screenshots of an example interface of a VR platform illustrate how the VR platform of the present disclosures allows for objects to be generated by the first user, and then shared to a second user and others having the same properties as created by the first user. In general, each object in a virtual environment is an instance of a base entity implemented as an Akka.NET agent, according to some embodiments. The object has a client part (ClientEntity3D) and server part (ServerEntity3D). During the implementation of an object, code generation is used to generate client and server templates from the object interface, which define all of the object's properties and methods. The code generator also creates the object-specific network protocol, which binds the methods on the client to methods on the server and vice versa.

The object is bound to an EntityBase, e.g., Akka.NET agent (see FIG. 2A). In some embodiments, the ServerEntity3D in fact is manifested as a message router and a realization of a network protocol for communication between the client-side entity and the base entity. The base entity processes all of the events and has an instance of ScriptManager (a container for all user-created scripts.) It also stores all data about the object state in persistent storage.

All entity objects are children of the global EntityManager, which is also implemented as an Akka.NET agent, according to some embodiments.

See the Appendix to Specification for example code implementing some of the features of the present disclosure. Code samples include ClientEntity3D, ServerEntity3D, EntityBase and ScriptManager; omitted code is marked by bookended sets of double hashmarks, e.g., //..//.

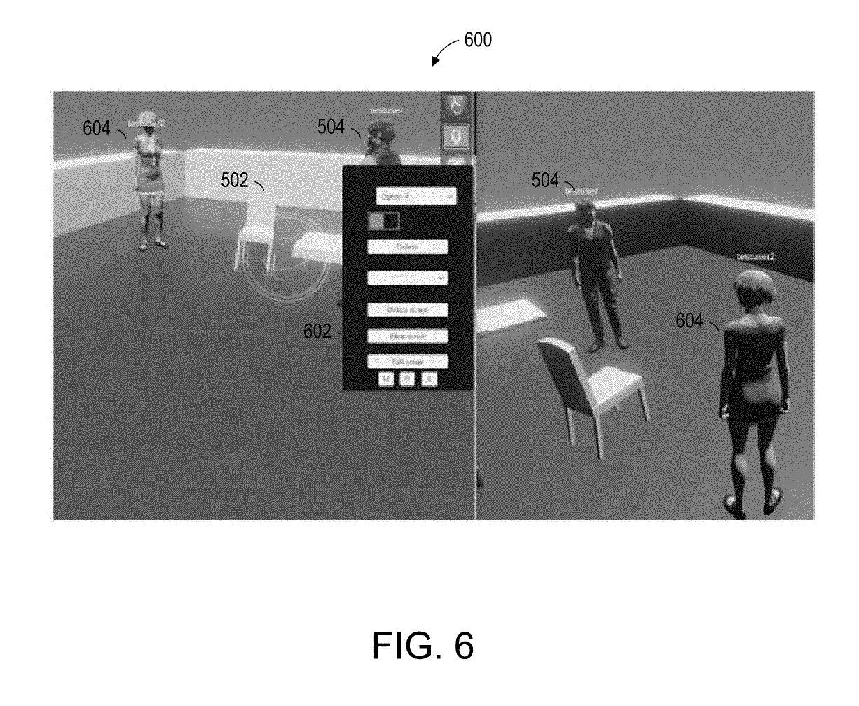

Referring to FIG. 5, shown in illustration 500 is an example VR environment of a first user, as expressed as avatar 504, uploading a new object in his environment. The new object in this case is a chair 502. In FIG. 6, shown in illustration 600 is a second user 604 who is also present in the same VR environment. The chair object 502 has been automatically converted into a server-side entity. All manipulations of the object are now visible for both the first user 504 and the second user 604. Shown is an example of part of a user interface 602 for changing some of the properties of the chair object 502.

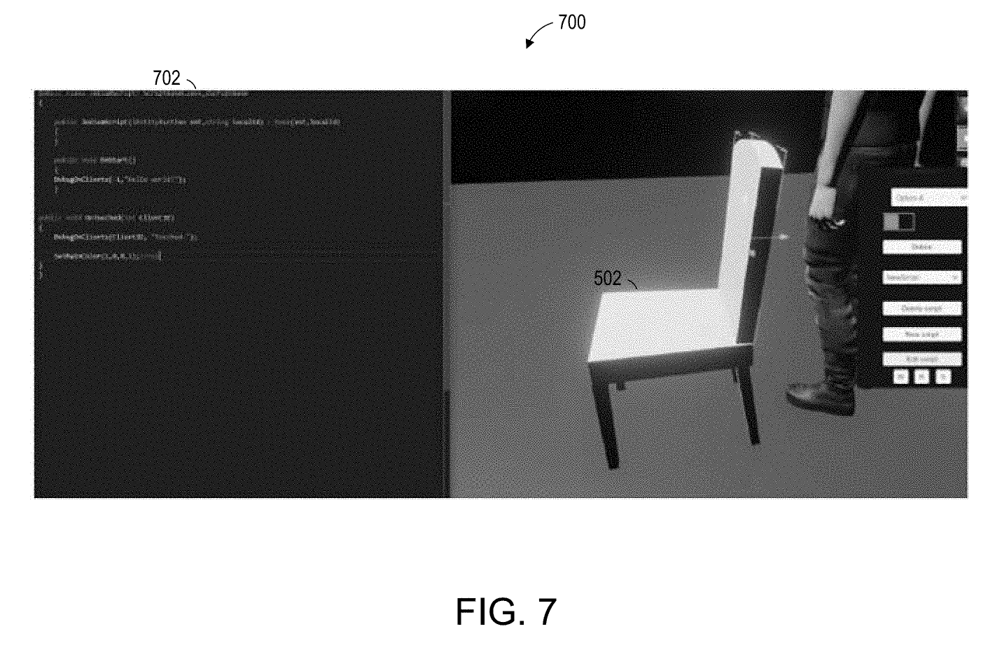

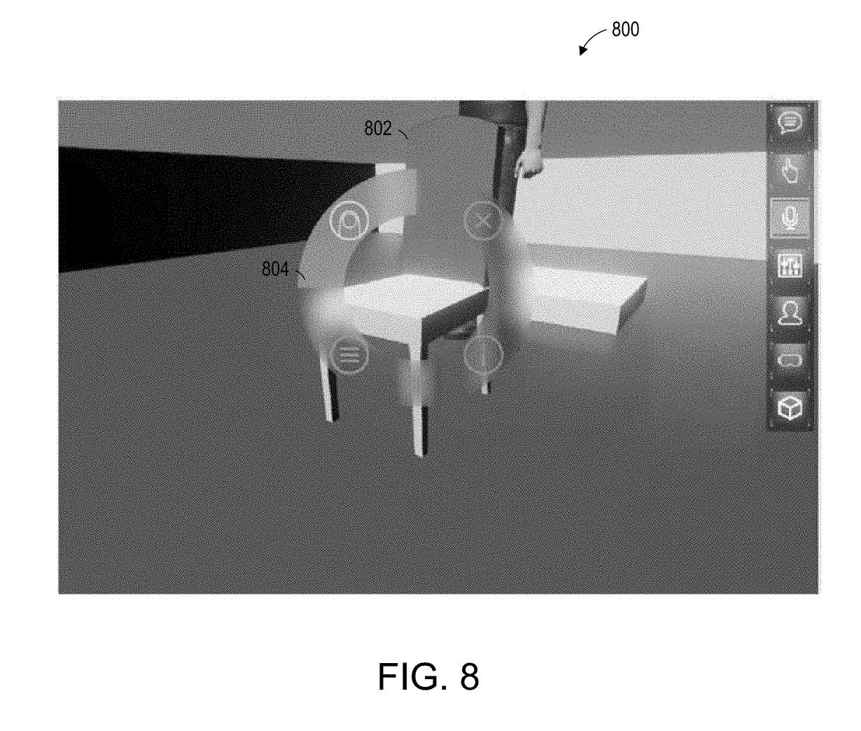

Referring to FIG. 7, in illustration 700, the first user now intends to modify one or more properties of the chair object 502. In this example, the first user creates a C# script 702 to describe the object behavior. The script 702 is uploaded to the server, compiled on the server-side and then uploaded on the entity agent. In this example, the first user 504 has added a property to the chair object 502 to change its color when it is touched. In FIG. 8, as shown in illustration 800, part of the object user interface 804 is shown surrounding the chair object. The touch icon is selected in this example, and upon selection it is shown that the back of the chair is now changed to a red color 802. This is consistent with the small modification made in the C# script of FIG. 7.

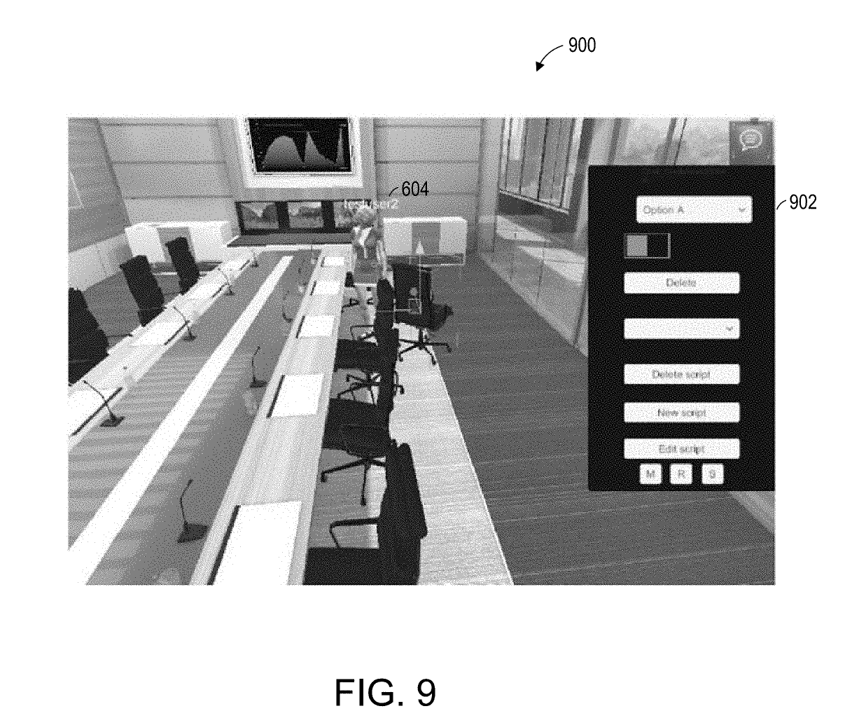

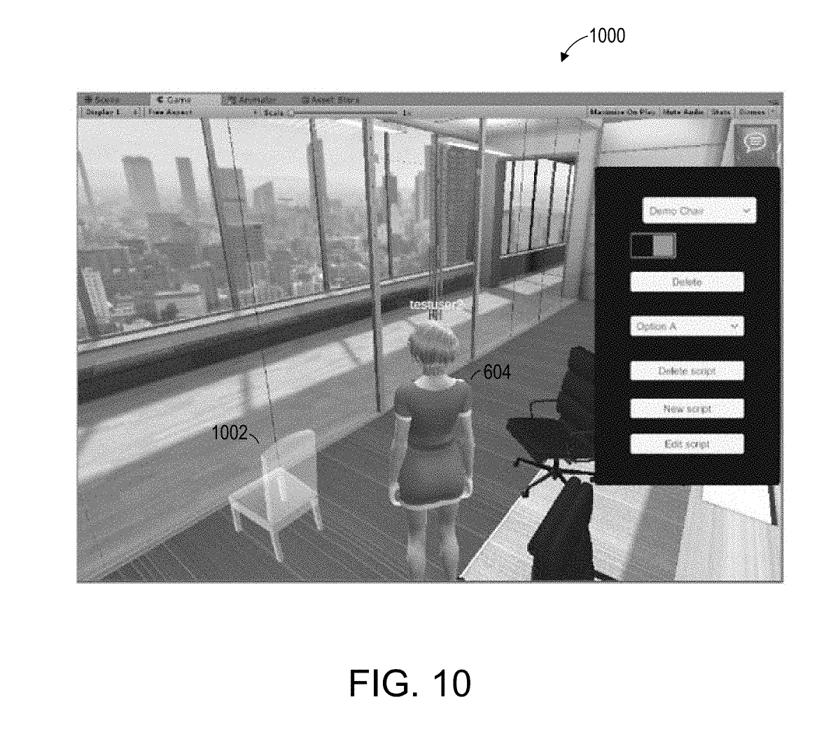

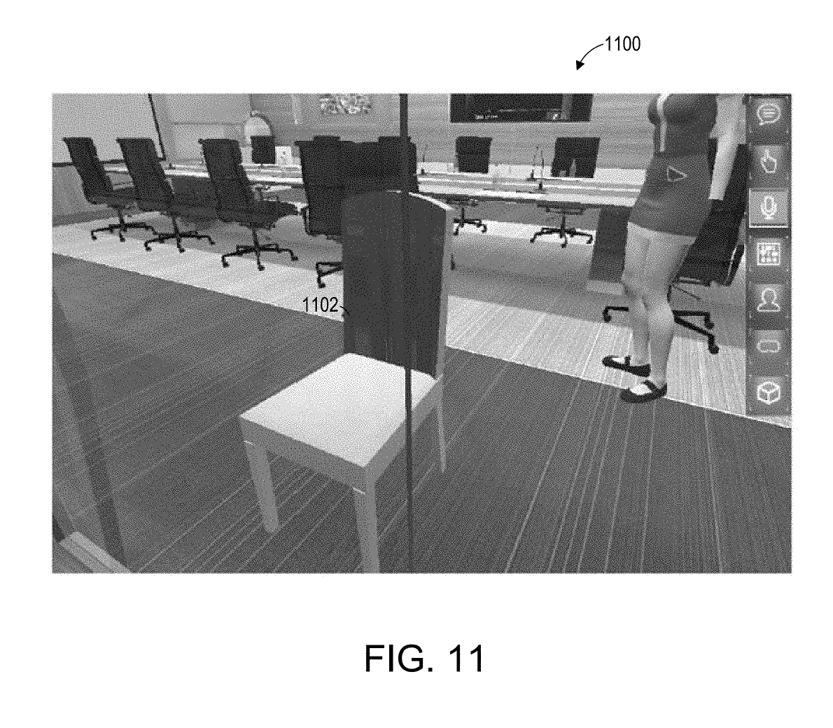

Referring to FIG. 9, shown in illustration 900 now is a new VR environment that the second user 604 has logged into. For example, this may be a completely new environment that the second user 604 has exclusive access to that the first user 504 does not. Shown are a number of different objects in this new environment. Here, the second user can select any number of the objects in the second VR environment and change their properties using the user interface 902, as shown. In FIG. 10, having seen the first user create the chair object, illustration 1000 shows the second user 604 now knows of its existence and chooses to download the same chair object into her second VR environment. The translucent depiction 1002 of the chair expresses that the chair is being instantiated into this second environment. In FIG. 11 (illustration 1100), the downloaded chair object 1102 is now shown, with the same changed red property that was modified to the chair object in the first be our environment by the first user. In general, any instance of an entity created by the first user that is downloaded by any other user in the VR network will be able to have changes to that entity in the other VR environments of which it is downloaded to. This is a scalable solution that is efficient in resources and easy to code for non-expert user, due to the unique VR architecture as implemented and proposed by the present disclosure.

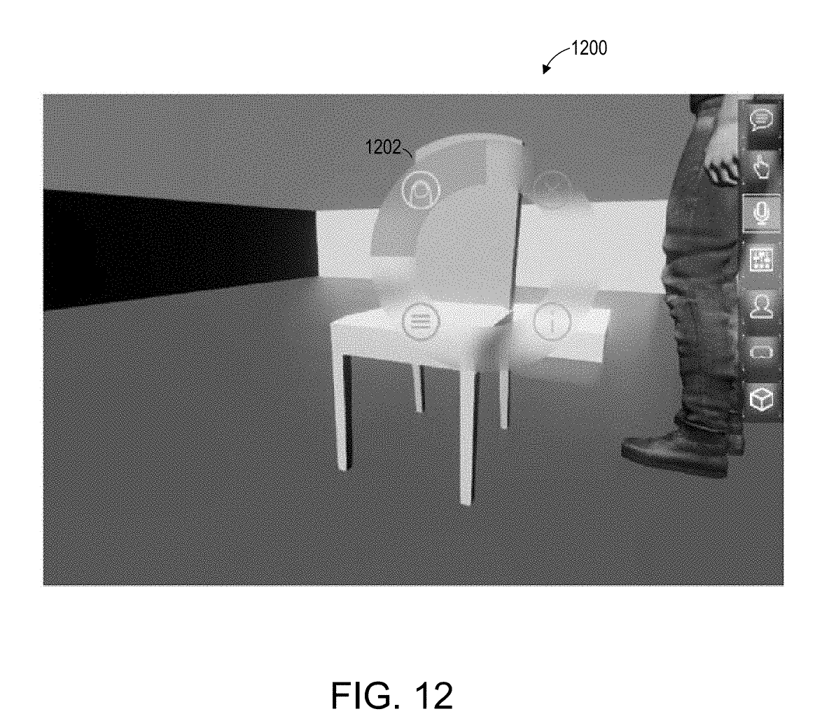

Referring to FIG. 12, back in the first VR environment of the first user as shown in illustration 1200, the first user 504 now changes a property of the chair object. In this example, he may have modified the script to change the back of the chair to a different color upon touching the object. Shown here now is the chair object with a green back 1202.

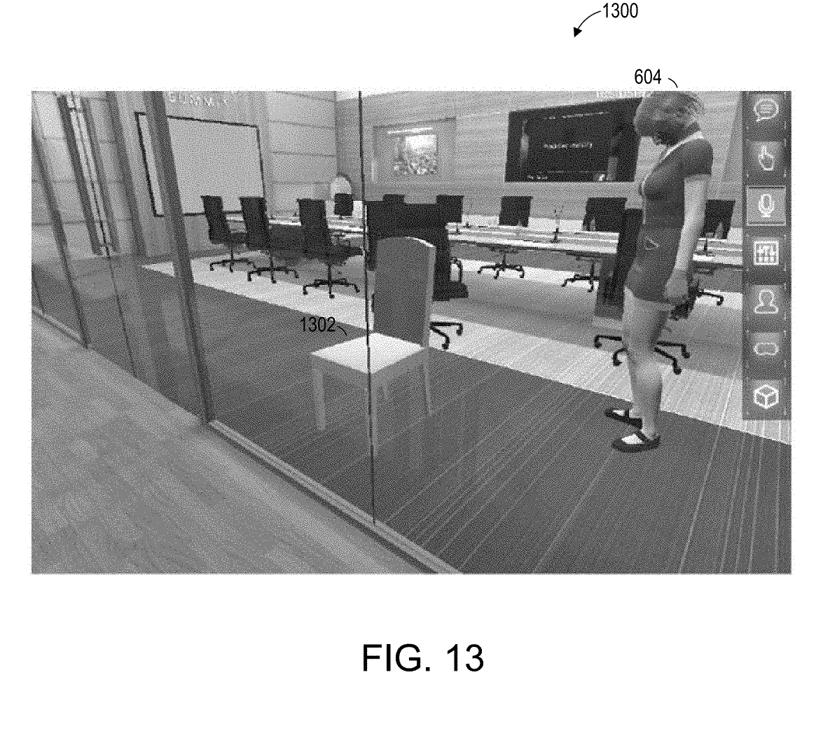

Finally, referring to FIG. 13, as shown in illustration 1300, without any manipulations by the second user 604 in her second VR environment, based on the change made by the first user of the chair object, the same chair object loaded into the second VR environment has now changed the properties to match the same behavior. As shown, the back of the chair 1302 is now green, consistent with the change made by the first user shown in FIG. 12.

As previously mentioned, an arbitrary number of objects can be modified across an arbitrary number of VR environments that are supported by the VR platform of the present disclosure. This is unlike conventional platforms that support multiple VR environments, because typically each VR environment does not possess the ability to share characteristics or objects between environments. This is typically because each VR environment according to conventional means are distinct, discrete entities that did not have any shared or global properties. Furthermore, each entity or object in conventional VR environments has one or more workers individually associated with it, such that manipulating the same type of object or entity in different VR environments will require that multiple workers need to be mobilized to make the changes to each other individual entity. In contrast, the VR platform of the present disclosure utilizes an inherently distinct and unique architecture that is agent-based. This allows for any object or other entity to be created and uploaded to a shared or global version of the object within one or more of the servers supporting the entire VR platform. Then, any arbitrary number of instantiations of the same object or entity can be downloaded into individual environments, based on the global version, sharing the same properties of the object or entity that is saved in the shared space of the VR platform.

Referring to FIG. 14, the block diagram illustrates components of a machine 1400, according to some example embodiments, able to read instructions 1424 from a machine-readable medium 1422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 14 shows the machine 1400 in the example form of a computer system (e.g., a computer) within which the instructions 1424 (e.g., software, a program, an application, an applet, an app, or other executable code) for causing the machine 1400 to perform any one or more of the methodologies discussed herein may be executed, in whole or in part.

In alternative embodiments, the machine 1400 operates as a standalone device or may be connected (e.g., networked) to other machines. In a networked deployment, the machine 1400 may operate in the capacity of a server machine 110 or a client machine in a server-client network environment, or as a peer machine in a distributed (e.g., peer-to-peer) network environment. The machine 1400 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1424, sequentially or otherwise, that specify actions to be taken by that machine. Further, while only a single machine 1400 is illustrated, the term “machine” shall also be taken to include any collection of machines that individually or jointly execute the instructions 1424 to perform all or part of any one or more of the methodologies discussed herein.

The machine 1400 includes a processor 1402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1404, and a static memory 1406, which are configured to communicate with each other via a bus 1408. The processor 1402 may contain microcircuits that are configurable, temporarily or permanently, by some or all of the instructions 1424 such that the processor 1402 is configurable to perform any one or more of the methodologies described herein, in whole or in part. For example, a set of one or more microcircuits of the processor 1402 may be configurable to execute one or more modules (e.g., software modules) described herein.

The machine 1400 may further include a video display 1410 (e.g., a plasma display panel (PDP), a light emitting diode (LED) display, a liquid crystal display (LCD), a projector, a cathode ray tube (CRT), or any other display capable of displaying graphics or video). The machine 1400 may also include an alphanumeric input device 1412 (e.g., a keyboard or keypad), a cursor control device 1414 (e.g., a mouse, a touchpad, a trackball, a joystick, a motion sensor, an eye tracking device, or other pointing instrument), a storage unit 1416, a signal generation device 1418 (e.g., a sound card, an amplifier, a speaker, a headphone jack, or any suitable combination thereof), and a network interface device 1420.

The storage unit 1416 includes the machine-readable medium 1422 (e.g., a tangible and non-transitory machine-readable storage medium) on which are stored the instructions 1424 embodying any one or more of the methodologies or functions described herein, including, for example, any of the descriptions of FIGS. 1-13. The instructions 1424 may also reside, completely or at least partially, within the main memory 1404, within the processor 1402 (e.g., within the processor's cache memory), or both, before or during execution thereof by the machine 1400. The instructions 1424 may also reside in the static memory 1406.

Accordingly, the main memory 1404 and the processor 1402 may be considered machine-readable media 1422 (e.g., tangible and non-transitory machine-readable media). The instructions 1424 may be transmitted or received over a network 1426 via the network interface device 1420. For example, the network interface device 1420 may communicate the instructions 1424 using any one or more transfer protocols (e.g., HTTP). The machine 1400 may also represent example means for performing any of the functions described herein, including the processes described in FIGS. 1-13.

In some example embodiments, the machine 1400 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1422 able to store data temporarily or permanently and may be taken to include, but not be limited to, random-access memory (RAM), read-only memory (ROM), buffer memory, flash memory, and cache memory. While the machine-readable medium 1422 is shown in an example embodiment to be a single medium, the term “machine-readable medium” should be taken to include a single medium or multiple media (e.g., a centralized or distributed database 115, or associated caches and servers) able to store instructions 1424. The term “machine-readable medium” shall also be taken to include any medium, or combination of multiple media, that is capable of storing the instructions 1424 for execution by the machine 1400, such that the instructions 1424, when executed by one or more processors of the machine 1400 (e.g., processor 1402), cause the machine 1400 to perform any one or more of the methodologies described herein, in whole or in part. Accordingly, a “machine-readable medium” refers to a single storage apparatus or device 120 or 130, as well as cloud-based storage systems or storage networks that include multiple storage apparatus or devices 120 or 130. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1422 is non-transitory in that it does not embody a propagating signal. However, labeling the tangible machine-readable medium 1422 as “non-transitory” should not be construed to mean that the medium is incapable of movement; the medium should be considered as being transportable from one physical location to another. Additionally, since the machine-readable medium 1422 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1422 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1402 or a group of processors 1402) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1402 or other programmable processor 1402. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1408) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1402 that are temporarily configured (e.g., by software) or permanently configured to perform the relevant operations. Whether temporarily or permanently configured, such processors 1402 may constitute processor-implemented modules that operate to perform one or more operations or functions described herein. As used herein, “processor-implemented module” refers to a hardware module implemented using one or more processors 1402.

Similarly, the methods described herein may be at least partially processor-implemented, a processor 1402 being an example of hardware. For example, at least some of the operations of a method may be performed by one or more processors 1402 or processor-implemented modules. As used herein, “processor-implemented module” refers to a hardware module in which the hardware includes one or more processors 1402. Moreover, the one or more processors 1402 may also operate to support performance of the relevant operations in a “cloud computing” environment or as a “software as a service” (SaaS). For example, at least some of the operations may be performed by a group of computers (as examples of machines 1400 including processors 1402), with these operations being accessible via a network 1426 (e.g., the Internet) and via one or more appropriate interfaces (e.g., an API).

The performance of certain operations may be distributed among the one or more processors 1402, not only residing within a single machine 1400, but deployed across a number of machines 1400. In some example embodiments, the one or more processors 1402 or processor-implemented modules may be located in a single geographic location (e.g., within a home environment, an office environment, or a server farm). In other example embodiments, the one or more processors 1402 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 1400 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A system of a virtual reality (VR) platform for generating shared entities in a plurality of virtual reality environments, the system comprising:
a first client portal configured to interface with a first user;
a first VR client domain communicatively coupled to the first client portal and configured to:
generate a first VR entity based on input by the first user, the first VR entity comprising visual characteristics and physical characteristics that can be interfaced within VR environments; and
cause display of the first VR entity generated by the first user;
a first data domain communicatively coupled to the first VR client domain and configured to store data associated with the visual and physical characteristics of the first VR entity;
a server communicatively coupled to the VR client and the first data domain and configured to store a global entity agent associated with the first VR entity, the global entity agent representing a global copy of the first VR entity comprising the same visual and physical characteristics as the first VR entity;
a second data domain communicatively coupled to the server and configured to access a copy of the global entity agent and store the copy as a second VR entity, the second VR entity comprising the same visual and physical characteristics as the global entity agent;
a second VR client domain communicatively coupled to the second data domain and configured to:
download the second VR entity based on input of a second user; and
cause display of the second VR entity, wherein the display of the second VR entity comprises the same visual and physical characteristics as the first VR entity; and
a second client portal communicatively coupled to the second VR client domain and configured to interface with the second user.

2. The system of claim 1, wherein:
the first client portal is further configured to receive an instruction from the first user to change a characteristic about the first VR entity;
the first data domain is further configured to change the characteristic about the first VR entity and store the change;
the first VR client domain is further configured to cause display of the changed characteristic about the first VR entity; and
the server is further configured to automatically change a same characteristic about the global entity agent based on the received instruction from the first user.

3. The system of claim 2, wherein:
the second data domain is further configured to access the changed characteristic of the global entity agent and automatically change a same characteristic about the second VR entity; and
the second VR client domain is further configured to automatically cause display of the changed characteristic about the second VR entity, based on the received instruction from the first user.

4. The system of claim 1, wherein the first data domain is further communicatively coupled to the first client portal, and the second data domain is further communicatively coupled to the second client portal.

5. The system of claim 1, wherein the first VR client domain is further configured to cause display of a first entity user interface configured to receive input to manipulate the first VR entity.

6. The system of claim 1, wherein the server is configured to cause a plurality of copies of the global entity agent that are each stored in different data domains to automatically change to a same characteristic in the plurality of copies whenever the same characteristic in the global entity agent is changed.

7. The system of claim 1, wherein the server is further configured to store a room agent associated with a room environment of the first VR client domain, the room agent comprising visual and physical characteristics associated with the room environment in the first VR client domain.

8. The system of claim 2, wherein the instruction from the first user to change the characteristic about the first VR entity is generated by a programming language script.

9. The system of claim 1, wherein the first VR client domain is further configured to be interfaced by the first user and the second user simultaneously.

10. The system of claim 1, further comprising a streaming server configured to cause display of both the first VR entity in the first VR client domain and the second VR entity in the second VR client domain.

11. A method of a virtual reality (VR) platform for generating shared entities in a plurality of virtual reality environments, the method comprising:
interfacing with a first user at a first client portal of the VR platform;
generating, at a first VR client domain of the VR platform, a first VR entity based on input by the first user, the first VR entity comprising visual characteristics and physical characteristics that can be interfaced within VR environments;
causing display of the first VR entity generated by the first user;
storing, in a first data domain of the VR platform, data associated with the visual and physical characteristics of the first VR entity;
storing, in a server of the VR platform, a global entity agent associated with the first VR entity, the global entity agent representing a global copy of the first VR entity comprising the same visual and physical characteristics as the first VR entity;
accessing, by a second data domain of the VR platform, a copy of the global entity agent;
storing, by the second data domain, the copy as a second VR entity, the second VR entity comprising the same visual and physical characteristics as the global entity agent;
downloading, by a second VR client domain of the VR platform, the second VR entity based on input of a second user;
causing display of the second VR entity, by the second VR client domain, wherein the display of the second VR entity comprises the same visual and physical characteristics as the first VR entity; and
interfacing with the second user by a second client portal of the VR platform.

12. The method of claim 11, further comprising:
receiving, by the first client portal, an instruction from the first user to change a characteristic about the first VR entity;
changing, by the first data domain, the characteristic about the first VR entity and storing the change;
causing, by the first VR client domain, display of the changed characteristic about the first VR entity; and
automatically changing, by the server, a same characteristic about the global entity agent based on the received instruction from the first user.

13. The method of claim 12, further comprising:
accessing, by the second data domain, the changed characteristic of the global entity agent and automatically changing a same characteristic about the second VR entity; and
automatically causing, by the second VR client domain, display of the changed characteristic about the second VR entity, based on the received instruction from the first user.

14. The method of claim 11, further comprising causing, by the first VR client domain, display of a first entity user interface configured to receive input to manipulate the first VR entity.

15. The method of claim 11, further comprising causing, by the server, a plurality of copies of the global entity agent that are each stored in different data domains to automatically change to a same characteristic in the plurality of copies whenever the same characteristic in the global entity agent is changed.

16. The method of claim 11, further comprising storing, by the server, a room agent associated with a room environment of the first VR client domain, the room agent comprising visual and physical characteristics associated with the room environment in the first VR client domain.

17. The method of claim 12, wherein the instruction from the first user to change the characteristic about the first VR entity is generated by a programming language script.

18. The method of claim 11, wherein the first VR client domain is further configured to be interfaced by the first user and the second user simultaneously.

19. A non-transitory computer readable medium comprising instructions that, when executed by a processor, cause the processor to perform operations comprising:
interfacing with a first user at a first client portal of the VR platform;
generating a first VR entity based on input by the first user, the first VR entity comprising visual characteristics and physical characteristics that can be interfaced within VR environments;
causing display of the first VR entity generated by the first user;
storing data associated with the visual and physical characteristics of the first VR entity;
storing a global entity agent associated with the first VR entity, the global entity agent representing a global copy of the first VR entity comprising the same visual and physical characteristics as the first VR entity;
accessing a copy of the global entity agent;
storing the copy as a second VR entity, the second VR entity comprising the same visual and physical characteristics as the global entity agent;
downloading the second VR entity based on input of a second user;
causing display of the second VR entity, wherein the display of the second VR entity comprises the same visual and physical characteristics as the first VR entity; and
interfacing with the second user by a second client portal of the VR platform.
